(19) United States
(12) Patent Application Publication
(10) Pub. No.: US 2016/0233006 A1
(43) Pub. Date: Aug. 11, 2016

(54) INTERLOCKING RIBBON CABLE UNITS AND ASSEMBLIES OF SAME

(71) Applicant: CommScope Technologies LLC, Hickory, NC (US)

(72) Inventors: John C. Chamberlain, Hickory, NC (US); Baber Abbas, Chicago, IL (US)

(21) Appl. No.: 14/994,654

(22) Filed: Jan. 13, 2016

Related U.S. Application Data
(60) Provisional application No. 62/113,859, filed on Feb. 9, 2015.

(51) Int. Cl. H01B 7/08; H01B 11/00

(52) U.S. Cl. CPC H01B 7/08; H01B 11/007

(57) ABSTRACT

A ribbon cable includes: a plurality of elongate signal-carrying members, the plurality of signal-carrying members arranged in a generally planar configuration; and a jacket that surrounds the signal-carrying members, the jacket having first and second opposed side edges. Each of the first and second side edges includes interlocking features configured to interlock with an adjacent ribbon cable with interlocking features. First and second ribbon cables can be formed into a chain, in which the interlocking features of the first side edge of the first ribbon cable are interlocked with the interlocking features of the second side edge of the second ribbon cable to form the chain. An assembly may include a structural member and a chain of ribbon cables as described above. In some embodiments, the structural member is a pole (such as the leg of an antenna tower), and the chain of ribbon cables entirely encircles the pole.

### RELATED APPLICATION

The present application claims the benefit of and priority from U.S. Provisional Patent Application No. 62/113,859, filed Feb. 9, 2016, the disclosure of which is hereby incorporated herein by reference in its entirety.

### FIELD OF THE INVENTION

The present invention relates generally to cables, and more particularly to the mounting of cables.

### BACKGROUND

State of the art cellular Radio Access Networks (RANs) are migrating to smaller cell sizes in order to deliver higher effective bandwidths to hand sets and create additional coverage. Some embodiments of these new small cell sites (sometimes deemed “MetroCells”) mount an antenna, a radio, and potentially a Baseband Unit on existing or new poles, which may be power poles, lighting poles, or the like. It is common to locate the cellular distribution antenna as high on the pole as possible for coverage, and locate the electronics, including the radio at “ladder height.” Ladder height (typically about 10 feet above street level) is low enough to maintain with a ladder and one technician, but high enough to deter vandalism. In this instance, a cable assembly of RF power cables, typically 50 ohm coaxial cable, connects the radio at ladder height to the antennae at the top of the pole. The cable assembly can have as few as one RF power transmission connection and may also have control conductors. The cable is often a low profile cable for reduced probability of weather damage or vandalism.

### SUMMARY

As a first aspect, embodiments of the invention are directed to a ribbon cable. The ribbon cable comprises: a plurality of elongate signal-carrying members, the plurality of signal-carrying members arranged in a generally planar configuration; and a jacket that surrounds the signal-carrying members, the jacket having first and second opposed side edges. Each of the first and second side edges includes interlocking features configured to interlock with an adjacent ribbon cable with interlocking features.

A chain of interlocked ribbon cables comprising first and second ribbon cables according as discussed above can be created. The interlocking features of the first side edge of the first ribbon cable are interlocked with the interlocking features of the second side edge of the second ribbon cable to form the chain.

As a second aspect, embodiments of the invention are directed to an assembly that includes a structural member and a chain of ribbon cables as described above. In some embodiments, the structural member is a pole (such as the leg of an antenna tower or a monopole), and the chain of ribbon cables entirely encircles the pole.

### BRIEF DESCRIPTION OF THE FIGURES

FIG. 1 is a top view of an interlocking ribbon cable according to embodiments of the invention.

FIG. 2 is a top view of two ribbon cables of FIG. 1 interlocking at their side edges.

FIG. 3 is a top view of an interlocking ribbon cable according to alternative embodiments of the invention.

FIG. 4 is a top view of three ribbon cables of FIG. 3 interlocking at their side edges.

FIG. 5 is a perspective view of three ribbon cables of FIG. 3 interlocked and mounted on a leg of an antenna tower.

FIG. 6 is a top view of the ribbon cables and tower leg of FIG. 5.

### DETAILED DESCRIPTION OF EMBODIMENTS OF THE INVENTION

The present invention is described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed herein can be combined in any way and/or combination to provide many additional embodiments.

Unless otherwise defined, all technical and scientific terms that are used in this disclosure have the same meaning as commonly understood by one of ordinary skill in the art to which this invention belongs. The terminology used in the above description is for the purpose of describing particular embodiments only and is not intended to be limiting of the invention. As used in this disclosure, the singular forms “a”, “an” and “the” are intended to include the plural forms as well, unless the context clearly indicates otherwise. It will also be understood that when an element (e.g., a device, circuit, etc.) is referred to as being “connected” or “coupled” to another element, it can be directly connected or coupled to the other element or intervening elements may be present. In contrast, when an element is referred to as being “directly connected” or “directly coupled” to another element, there are no intervening elements present.

Referring now to the figures, a ribbon cable according to embodiments of the invention, designated at 10, is shown in FIG. 1. The ribbon cable 10 is elongate and includes a plurality of conductors 12 encased in a jacket 14 that separates the conductors 12 from each other. The conductors 12 may be coaxial conductors, twisted pair conductors, or the like of the type known to those of skill in this art. Also, in some alternative embodiments, the conductors may be replaced with optical fibers or fiber optic cables, or the cable may be a hybrid cable that includes both optical fibers and electrical conductors. In some instances, such as the illustrated embodiment, the conductors 12 may be encased in inner jackets 13 to form individual cables, with the jacket 14 overlying the inner jackets 13; in other instances, the jacket 14 may be formed directly over the conductors 12. As is also the case in the illustrated embodiment, the jacket 14 may include web sections 15 between conductors that provide pliability and flexibility to the ribbon cable 10.

As can be seen in FIG. 1, the side edges of the jacket 14 include hooks 16, 18 that provide interlocking capability. The hook 16 is open toward one side of the cable 10, whereas the hook 18 is open toward the opposite side of the cable 10. As shown in FIG. 2, adjacent ribbon cables 10, 10′ can be interlocked in side-by-side relationship by intermeshing the hooks 16, 18. It will be understood that additional interlocking ribbon cables can be added to the side edges of the ribbon cables 10, 10′ to form a “daisy chain” of interlocking ribbon cables.

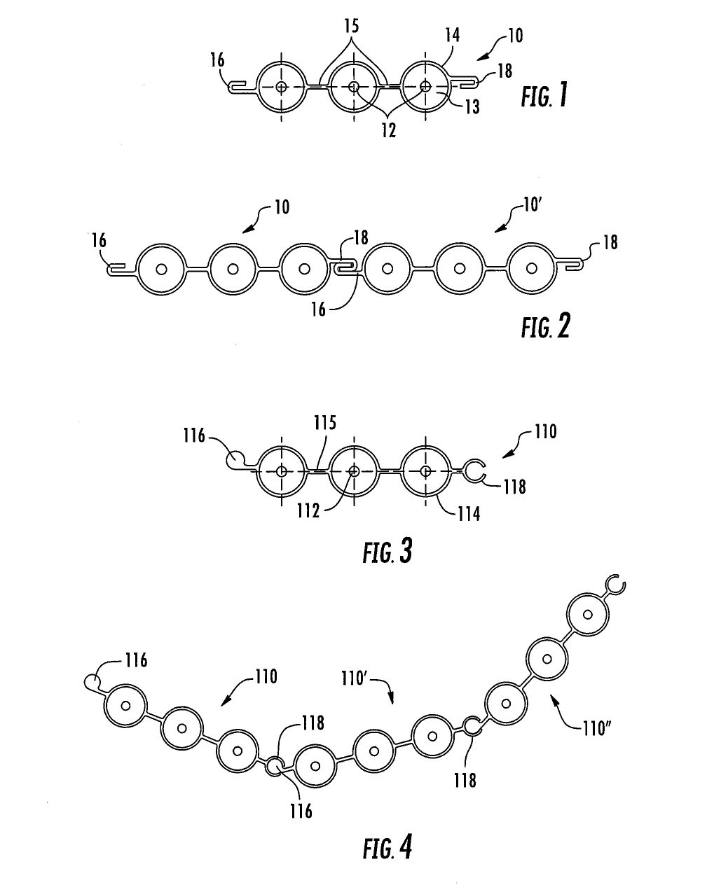

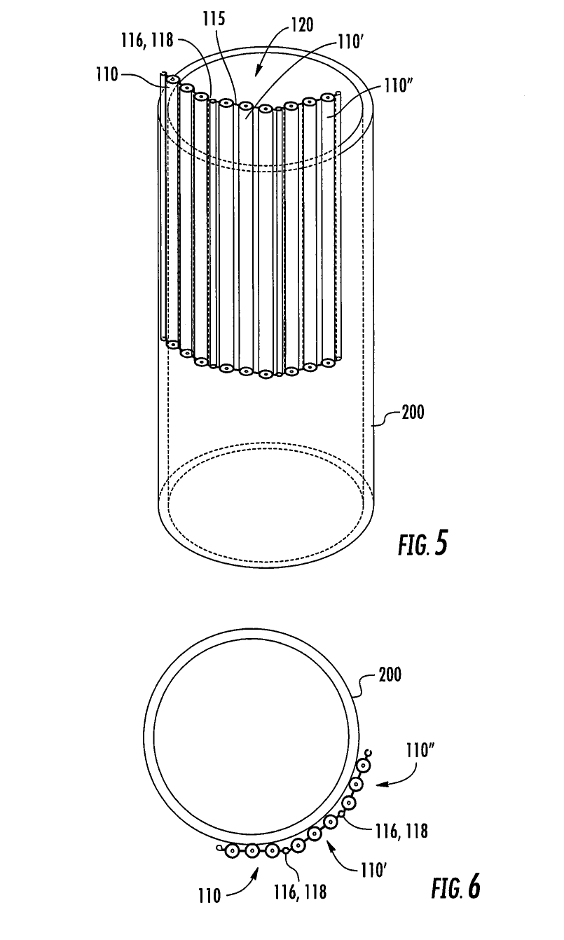

Those skilled in this art will appreciate that other interlocking features may be employed with ribbon cables according to embodiments of the invention. FIG. 3 illustrates an alternative ribbon cable 110 with conductors 112 and a jacket 114 that includes a nub 116 on one side edge and a clip 118 on the opposed side edge. As can be seen in FIG. 4, the nub 116 of one ribbon cable 110 can be interlocked with the clip 118 of an adjacent ribbon cable 110′. It can also be seen in FIG. 4 that the nub 116 can rotate slightly within a capturing clip 118, which can enable adjacent ribbon cables 110, 110′ to pivot slightly relative to each other.

Those skilled in this art will recognize that other interlocking features may also be employed, including different configurations of hooks, fingers, latches, nubs, channels, grooves, “hook-and-loop” surfaces, and the like, that can interlock with the features of an adjacent ribbon cable. In some embodiments, the features are identical on the sides edges of each ribbon cable, and in other embodiments the features are different on the side edges of each ribbon cable, with the features on one side edge being interlockable with the features of the opposite side edge.

As shown in FIGS. 5 and 6, a chain 120 of interlocked ribbon cables 110, 110′, 110″ can be mounted to overlie a structure, such as the leg 200 of an antenna tower, a power pole, the outer wall of a building, or the like. The chain 120 of ribbon cables 110, 110′, 110″ can be mounted to lay reasonably flat against the structure, which can (a) help to protect the cables against damage, (b) reduce the risk of an object “catching” on the cables, and (c) improve aesthetic appearance of the mounted cables. The presence of interlocking features, such as the nub 116 and clip 118, that can pivot and/or the presence of flexible web segments 115 between the conductors of the ribbon cable can facilitate flexure of the chain 120 as it is wrapped around the structure.

In some embodiments, the ribbon cables may encircle the pole or other structure entirely; in other embodiments, the ribbon cables may only partially encircle the pole, and the cables may mounted to the pole via other fastening means, such as hook-and-loop material, adhesives, ties, straps, threaded fasteners, or the like.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention.

That which is claimed is:

1. A ribbon cable, comprising:
a plurality of elongate signal-carrying members, the plurality of signal-carrying members arranged in a generally planar configuration;
a jacket that surrounds the signal-carrying members, the jacket having first and second opposed side edges;
wherein each of the first and second side edges include interlocking features configured to interlock with an adjacent ribbon cable with interlocking features.

2. The ribbon cable defined in claim 1, wherein the jacket includes web sections between the conductors.

3. The ribbon cable defined in claim 1, wherein the interlocking features of the first side edge differ from the interlocking features of the second side edge.

4. The ribbon cable defined in claim 1, wherein the signal-carrying members are electrical conductors.

5. The ribbon cable defined in claim 1, wherein an inner jacket surrounds each of the respective conductors, and wherein the jacket is formed over the inner jackets.

6. The ribbon cable defined in claim 1, wherein the interlocking features are configured to pivot relative to each other.

7. A chain of interlocked ribbon cables comprising first and second ribbon cables according to claim 1, wherein the interlocking features of the first side edge of the first ribbon cable are interlocked with the interlocking features of the second side edge of the second ribbon cable.

8. The chain of ribbon cables defined in claim 7, wherein the interlocking features of the first side edge differ from the interlocking features of the second side edge.

9. The chain of ribbon cables defined in claim 8, wherein the interlocking features of the first edge are configured to pivot relative to the interlocking features of the second edge.

10. The chain of ribbon cables defined in claim 7, wherein the jackets of the first and second ribbon cables include web sections between the conductors.

11. The chain of ribbon cables defined in claim 7, wherein the signal-carrying members are electrical conductors.

12. An assembly, comprising:
a structural member, and
a chain of ribbon cables as defined in claim 7 mounted to the structural member.

13. The assembly defined in claim 12, wherein the chain of ribbon cables overlies the structural member.

14. The assembly defined in claim 12, wherein the structural member comprises a pole.

15. The assembly defined in claim 14, wherein the chain of ribbon cables is arranged to encircle the pole entirely.

16. The assembly defined in claim 14, wherein the pole is a leg of an antenna tower.

17. The assembly defined in claim 12, wherein the interlocking features of the first side edge differ from the interlocking features of the second side edge.

18. The assembly defined in claim 12, wherein the signal-carrying members are electrical conductors.

19. The assembly defined in claim 12, wherein the interlocking features of the first edge are configured to pivot relative to the interlocking features of the second edge.

20. The assembly defined in claim 12, wherein the jackets of the first and second ribbon cables include web sections between the conductors.
